(19) United States
(12) Patent Application Publication
(10) Pub. No.: US 2004/0026045 A1
(43) Pub. Date: Feb. 12, 2004

(54) Floor covering removal tool

(76) Inventor: George Kenneth Adleman JR., Loma, CO (US)

Correspondence Address: EDWIN L. HARTZ, 2537 FALLS VIEW CIRCLE DR., GRAND JUNCTION, CO, 81505, US

(21) Appl. No.: 10/456,441

(22) Filed: Jun. 6, 2003

Related U.S. Application Data
(60) Provisional application No. 60/387,108, filed on Jun. 8, 2002.

(51) Int. Cl. B66F 3/00; B32B 1/00

(52) U.S. Cl. 156/584; 254/131; 254/131.5

(57) ABSTRACT

A floor cover removal tool having a pair of opposed sets of pins, one set to grip the floor covering to be removed and the other set to grip the floor covering to stabilize the tool and provide a stop to push against.

This application relies on the priority of provisional application No. 60/387,108 filed Jun. 8, 2001 entitled Floor Covering Removal Tool.

### BACKGROUND OF THE INVENTION

1). Field of Invention

This invention relates to the removal of floor covering, such as, e.g., carpet or vinyl, adhesively secured to a substrate of a floor or stairs and more particularly to an easy-to-use tool for starting the removal by pulling up an edge or portion of the material to be removed.

2). Related Art

Floor covering, such as carpet or vinyl, is often glued to a substrate such as wood or concrete. The removal of floor covering and particularly carpet adhesively secured to a substrate, has been addressed a number of U.S. Patents. Various devices, or tools, have been disclosed and are in use today. Many of these devices tend to be bulky, expensive and often take considerable time to set up for operation. A simple device that has proven to be very effective is disclosed in U.S. Pat. No. 6,386,476 issued to the inventor of the tool of this application. Many floor covering removal tools in use today, including the applicants tool, require that an edge of the floor covering be pulled up to be attached to the floor covering removal tool.

### SUMMARY OF THE INVENTION

The problem of getting the removal started, whether against a wall, in a corner, on stairs or out in the open is overcome by the simple tool of this invention. The starter tool consists of two sets of teeth or pins that are in parallel rows and opposing relationship to grip the floor covering near the edge and to hold the tool in place on the floor covering. The first set of pins are in a row and inclined downward when the handle of the tools is in a vertical position to engage the floor covering to start the removal of the floor covering from the substrate. This first set of pins or main set of pins is attached to an elongated rigid handle. The main set of pins are attached to the lower end of the handle and an area to grip the handle is at the opposite end of the handle.

The handle also carries the second set of pins, which are attached to the end of a leg that is pivotally attached to the handle directly or through an arcuate or curved body. The arcuate body runs from the bottom of the handle to a location up the handle at the front of the handle to provide a rigid surface for rolling the tool as the tool pulls the edge and a portion of the carpet loose from the substrate. The second set of pins are attached to one end of a leg, while the other end or opposite end of the leg is pivotally attached to either the handle or the arcuate body. A hinge pin runs through an opening at this opposite end of the leg with the hinge pin being attached either to the arcuate body or the handle.

The leg has an operating position where it is at an angle to the handle and engages the floor covering to be removed at a distance from the main pins and holds the tool in position while the edge and a portion of the floor covering is being pulled up from the substrate. A second position of the leg is with the leg nearly parallel to the longitudinal axis of the handle and is held in this position either mechanically or magnetically. A safety bar is attached to the handle to receive the sharp ends of the second set of pins to cover the ends of the pins while the tool is not in use or is being carried.

The length of the handle is 17″ and may be longer or shorter for operation while kneeling or bending over. Alternatively the handle is 3′ in length and may be 3 feet to 4 feet long so that the tool may be operated while standing.

All parts of the tool are made of sufficiently rigid material to withstand the stresses placed upon the parts in operation. The pins are preferably made of hardened steel, while the handle is made of steel or some other rigid material, such as aluminum or plastic. Similarly the leg and arcuate body are also made of steel or similarly rigid material. The row of main pins have a width of 2 or more inches as required to loosen a desired strip of floor covering from the substrates. The tool securing pins may have the same width as the main pins or may be wider or narrower as desired.

In operation, the two set of opposing pins are forced into the floor covering to be removed using a leveraged downward motion to secure the pins into the floor covering. The main pins go into the floor covering near the edge to be removed and the tool securing pins go into the floor covering behind the removal tool to secure the tool in position. The floor covering is then pulled up by pulling the handle back on the arcuate body to remove the edge and a portion of the floor covering from the substrate.

Objects, features and advantages of this invention will become apparent from a consideration of the description, the appended claims and the accompanying drawing.

### BRIEF DESCRIPTION OF THE DRAWINGS

FIG. 1 is a left side elevation of the starting tool for removing floor covering in a starting position in accordance with this invention;

FIG. 2 is a left side elevation of the starting tool in an operating position, in accordance with this invention;

FIG. 3 is a left side elevation view of the starting tool in another operating position after the edge of the floor covering has been pulled loose from the substrate and the leg with tool positioning pins has been placed in the rest position, in accordance with this invention;

FIG. 4 is a left side elevation view of the starting tool in the usual operating position upon completion of pulling up the edge and a portion of the floor covering to be removed, in accordance with this invention;

FIG. 5 is a perspective view of the starter tool from the left front of the tool, in accordance with this invention; and

FIG. 6 is a left side elevation view of an alternative embodiment of the starter tool, in accordance with this invention.

### DESCRIPTION OF PREFERRED EMBODIMENTS

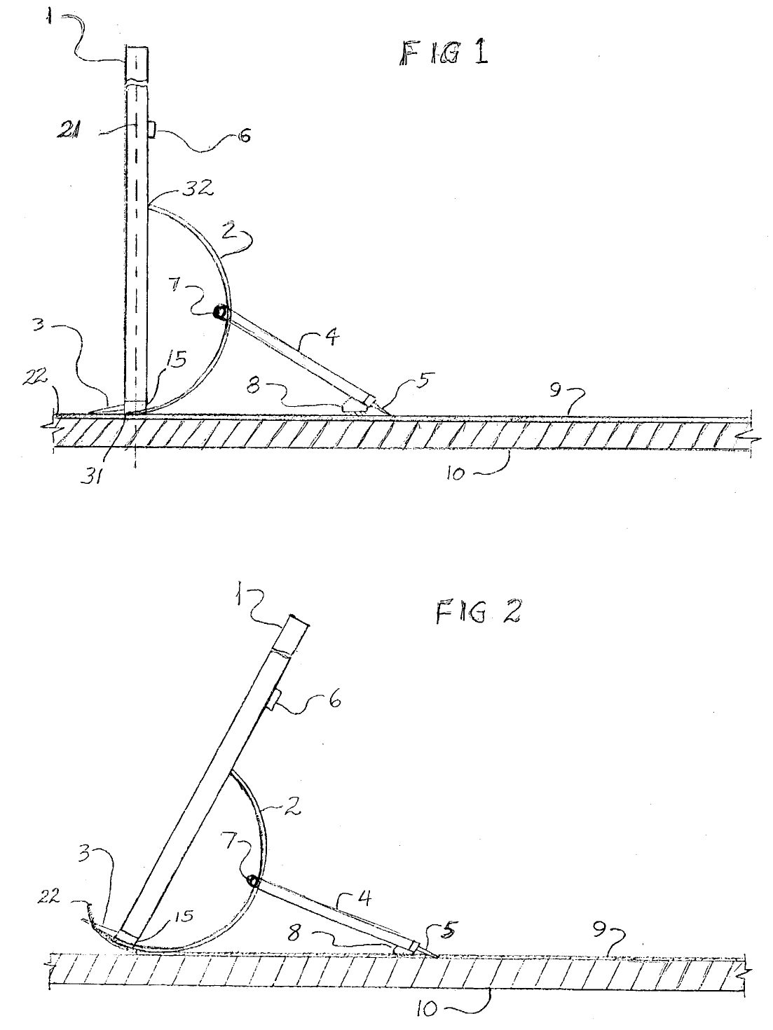

The tool for starting the removal of floor covering, shown in FIGS. 1-5 has a rigid elongated handle 1. The handle 1 has a longitudinal axis 21. The handle may be round or square or some other configuration. The preferred configuration is a square hollow bar having a length of approximately 17″. The handle may be shorter or longer than 17″, but it has to be long enough to accommodate the other parts of the tool. Also, the longer the handle, the greater the leverage provided for loosening the floor covering that is to be removed.

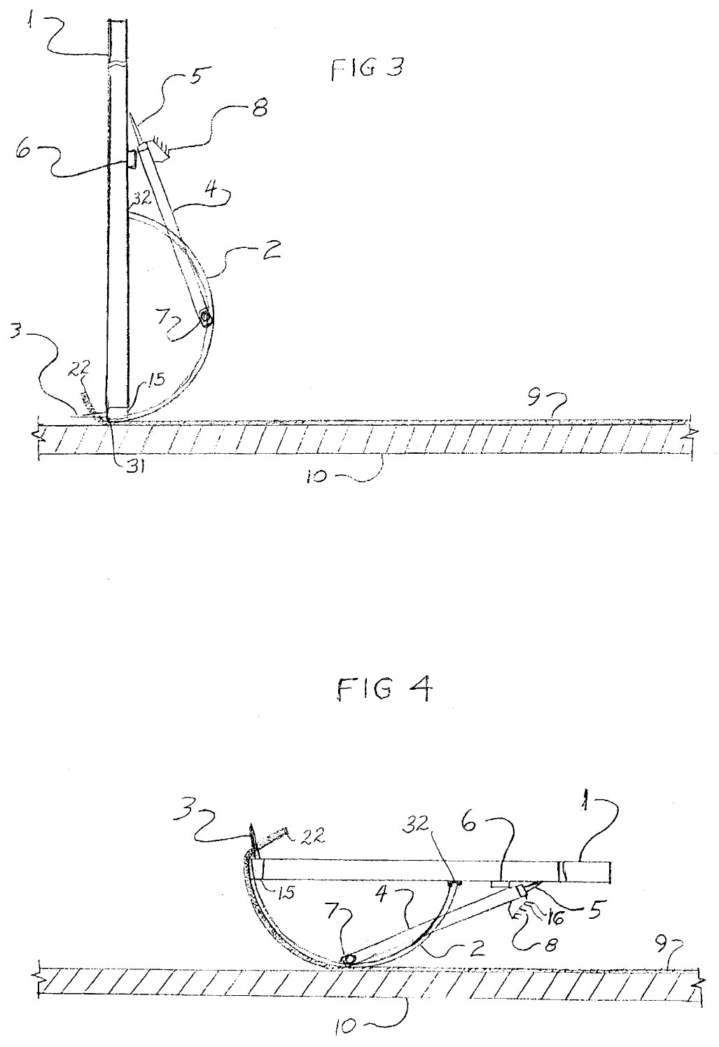

A first set of pins or main pins 3 are attached at the end of the handle 1 for engaging the floor covering to be removed. The main pins 3 have sharpened points and are preferably made of hardened steel to withstand the stresses encountered in loosening floor covering in use. The handle 1 is made of 1″ square hollow bar steel. The handle 1 may be made of some other rigid material such as heavy aluminum or heavy plastic. The main pins 3 are attached to a bar 15 that has a longitudinal axis that is perpendicular to the longitudinal axis of handle 1 and is attached to the bottom of the handle. Bar 15 is attached to handle 1 by welding or some other securing means. The length of the bar 15 determines the maximum width of the row of main pins 3. The width of the main pins 3 is sufficient to loosen at least a useful tab or width of floor covering that is to be removed. A typical width for main pins 3 is 2½″. However, the width can be less than or greater than 2½″, the wider the width, the greater the stress placed on the tool in use and the more force it takes to loosen the edge of the floor covering. The main pins 3 are in a row and extend downwardly relative to the longitudinal axis 21 of the handle 1 when in a vertical position. These pins extend below the bottom of the handle to engage the floor covering. Attached to the bottom of the handle, below bar 15, is an edge of an arcuate body 2. This body 2 is also made of a rigid material to withstand the forces encountered in operation. The curve of the body 2 may be an arc of an circle or some other configuration that provides a surface for exerting pressure on the floor covering to pull it up from the substrate as the tool rolls on the curved surface. The curve of the arc of a circl of the tool of FIGS. 1-5 has a radius of 2½″. This radius, of course, only needs to be sufficient to provide a surface upon which the tool may be rolled to loosen the edge and a portion of the floor covering to be removed as shown in FIG. 4. The body 2 has a length that is the same as the length of the bar 15. The body 2 has a first edge 31 at the bottom of the handle 2 that is attached to the bar 15 by a weld joint. The body has a top edge 32 with the center portion attached to the handle 1 by a weld joint. The body 2 strengthens the tool and the coupling between the handle 1 and the main pins 2 through bar 15. In this way, as the tool is used in operation by pulling the handle from the vertical position toward the horizontal position, as shown in FIG. 4, the tool rolls on the body 2.

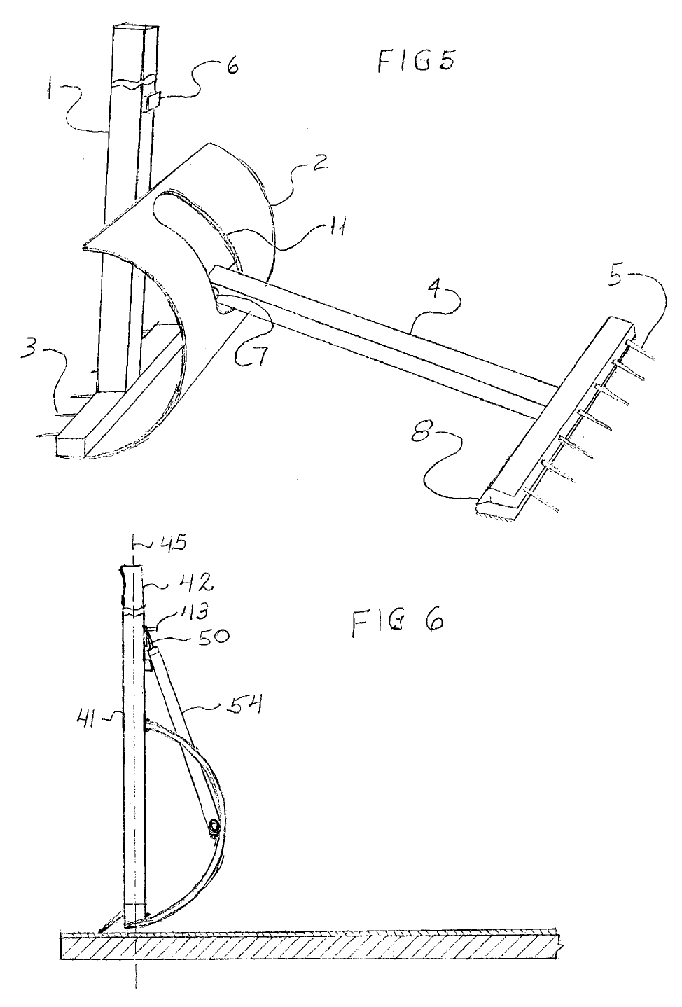

A positioning leg 4 is pivotally attached to body 2 by a hinge pin 7 that is mechanically attached to the inside curve of body 2. The leg 4 extends from the hinge pin 7 and terminates in a second set of pins, or leg pins 5. Also attached to the leg 4 at the leg pins 5 end of the leg is a pin plate 8 to assist in securing the tool at the selected position on the floor covering. Pin plate 8 carries a plurality of pins 16 in rows and columns. The pins 16 of the pin plate 8 assist the leg pins 5 in securing the tool in position in its initial operation. The row of leg pins 5 has the same width as the main pins 3. However, the width of leg pins 5 may differ from the width of main pins 3. In any case, the width of the leg pins 5 is sufficient to stabilize and hold the tool in position during the initial operation to engage the edge of the floor covering to be removed by the main pins 3. The leg pins 5 are also preferably made of hardened steel and sharpened to provide ease of entry into the floor covering to be removed. There is a slot 11 in the arcuate body 2 to permit the leg 4 to be pivotally moved from it's rest position, shown in FIGS. 3 & 4, to its tool stabilizing and stop position, shown in FIGS. 1 & 2. This slot 11 is most easily seen in FIG. 5. The leg 4 is shown as a square bar in FIG. 5. However, this leg 4 may be a round bar or some other suitable configuration. Leg 4 is also made of steel or some other rigid material. The tool further includes means for securing the leg 4 in a rest position. This means is a magnet 6. Some other mechanical means for holding the leg in the position against the handle 1 as shown in FIGS. 3 & 4 may also be used.

In operation, the tool is placed near the edge 22 of the floor covering to be removed 9, which is secured to a substrate 10. The initial position of operation is shown in FIG. 1, where the leg 4 is in the down position and the pins 16 of pin plate 8 and leg pins 5 are engaging the floor covering to secure the tool in place. Pins 5 alone, or in combination with pins 16, when inserted in the floor covering, provide a stop to keep the tool from moving away from the edge engaged by the main pins 3. The two sets of opposing pins, i.e. the main pins 3 and leg pins 5, are forced into the floor covering to be removed by using a leveraged downward motion on the handle 1 to secure the main pins 3 into the floor covering. Once the main pins 3 are in the floor covering 9, the handle 1 is pulled toward the user and the edge of the floor covering 9 is loosened from the substrate 10 as shown in FIG. 2. The handle 1 is then returned to it's vertical position to disengage the leg pins 5 and the leg 4 is pivoted to engage the handle 1 and to be secured in place by the securing means or securing device 6. Once the leg 4 is held in it's rest position as shown in FIG. 3, the handle 1 is again pulled down from the vertical position toward the horizontal position to loosen a further portion of the floor covering 9 from the substrate or floor 10, as shown in FIG. 4. Once the desired portion of floor covering 9 has been loosened from the substrate or floor 10, the tool is pushed toward it's upright position to remove the main pins 3 from the loosened tab or edge of the floor covering 9. With the leg 4 in it's rest position, the tool can then be moved to the next location for loosening another edge or tab of the floor covering 9.

An alternative embodiment of the starter tool is shown in FIG. 6. The tool of FIG. 6 differs in that a handle 41 has a grip 42 at the end of the handle that is gripped by the user. The grip 42 is made of rubber and had indentations to fit the hand of the user. A further difference is that the tool of FIG. 6 does not have the pin plate 8 of the tool of FIGS. 1-5 and the tool of FIG. 6 has a safety plate 43 made of angle iron that is welded to the handle 41. The plate 43 has a length that accommodates the width of the leg pins 50 when the leg 54 is in the rest position, as shown in FIG. 6. This is a safety measure to cover the sharp ends of the pins 50 to protect the user of the tool when transported from one location to another.

Although preferred embodiments of the starter tool or floor covering removal tool have been shown and described above, the invention is not limited to these specific embodiments, but rather the scope of the invention is to be determined as claimed.

What is claimed is:

1. A starter tool for floor covering removal comprising a first set of pins to engage the floor covering in a first location where the floor covering is to be loosened and a second set of pins to engage the floor covering in a second location to provide a stop to push against.

2. A starter tool in accordance with claim 1, wherein the second set of pins is aligned parallel with the first set of pins.

3. A starter tool in accordance with claim 1, further comprising an elongated handle carrying the first set of pins at one end of the handle.

4. A starter tool in accordance with claim 3, further comprising a bar aligned perpendicular to the longitudinal axis of the handle and attached to the end of the handle, with the first set of pins attached to the bar.

5. A starter tool in accordance with claim 4, further comprising an arcuate body having one edge attached to the bar and the second edge attached to the handle.

6. A starter tool in accordance with claim 5, further comprising a leg pivotally attached to the arcuate body with the leg carrying the second set of pins at the end remote from the pivot point.

7. A starter tool in accordance with claim 6, wherein the arcuate body has a slot to accommodate the leg for pivotally moving between an operating position and a rest position.

8. A starter tool in accordance with claim 7, further comprising a second bar attached to the remote end of the leg and a pin pad attached to the second bar on the side of the leg remote from the handle in the rest position.

9. A starter tool for floor covering removal comprising a first set of pins positioned in a row to engage in a first location the floor covering to be removed, a second set of pins in a row to engage in a second location the floor covering to be removed, the row of second pins being parallel to the row of first pins.

10. A starter tool in accordance with claim 9, wherein the second set of pins is attached to an end of a leg, means for pivotally mounting the leg at the end remote from the second set of pins, wherein the leg has a rest position and an operating position, and a safety bar attached to the handle for covering the sharp ends of the second set of pins when the leg is in the rest position.
